(19) United States
(12) Patent Application Publication
(10) Pub. No.: US 2009/0313124 A1
(43) Pub. Date: Dec. 17, 2009

(54) Street-Level Routing

(75) Inventors: Hermelo Miranda, Key Largo, FL (US); Telmo Sampaio, Miami, FL (US)

Correspondence Address: HOLLAND & HART, LLP, P.O BOX 8749, DENVER, CO, 80201, US

(73) Assignee: Blue Dasher Technologies Inc., Miami, FL (US)

(21) Appl. No.: 12/484,840

(22) Filed: Jun. 15, 2009

Related U.S. Application Data
(60) Provisional application No. 61/061,516, filed on Jun. 13, 2008.

(51) Int. Cl. G01C 21/36; G06Q 30/00

(52) U.S. Cl. 705/14.58; 701/200

(57) ABSTRACT

A system and method for providing a street route to a user. A server communicates with a user and a routing engine. Database includes spherical photographic images, street vectors, and parcel coordinates. User gives start and end addresses and requests a route. Start and end addresses are sent to routing engine which responds with parsed start and end addresses and route therebetween. Exact start and end locations are calculated with reference to street vectors and parcel coordinates in the database. Spherical photographic images corresponding with calculated start and end locations, and display points calculated with reference to maneuver points provided by routing engine, are retrieved. Rectangular images are created corresponding with start and end locations and display points. Graphical navigation aids are superimposed on images. Optionally, advertising is inserted at appropriate points on images. A report is provided to the user.

### CROSS-REFERENCE TO RELATED APPLICATIONS

This patent application claims priority from provisional patent application Ser. No. 61/061,516 filed 13 Jun. 2008. This patent application is related to co-pending patent application Ser. No. 12/059,841 filed 31 Mar. 2008, and to provisional patent application No. 61/065,036 filed 8 Feb. 2008. The entire contents of all said patent applications are incorporated herein by this reference.

### BACKGROUND

Electronic systems that generate a route map and textual directions for a proposed trip from a starting address to a destination address are known. Some examples that are available on the Internet include Mapquest (www.mapquest.com), Yahoo (www.maps.yahoo.com), and Google (www.google.com/maps). These services typically generate a trip plan that guides a user from a point known to the service to be reasonably near the user's actual starting location to a point known to the service to be reasonably near the user's actual desired destination. This type of plan may include a route map and textual directions. The plan may also include detail maps or images of portions of the route. The plan can be viewed on a computer monitor or printed and carried with the user for reference during the journey. Some such plans may also be viewable on a portable electronic device such as a cell phone.

The user's exact starting location or desired destination may not be precisely known to the electronic system that generated the trip plan. In such a case, the locations of these features may not be accurately depicted in the plan, which can create difficulties for the user. Even if all points are accurately depicted in the plan, users sometimes make errors in following the textual directions or the route map, and sometimes the user may become disoriented even without making actual errors. Display of a route map on a portable device, especially if the display moves dynamically according to the user's changing location during the journey, may require extensive computing power in the device.

Accordingly, there is a need for a way to generate a trip plan that accurately depicts the user's actual starting location and destination, that enables the user to navigate along the planned route without getting disoriented, and that does not impose high computational demands on portable devices used to display the route.

### SUMMARY OF THE INVENTION

In one embodiment, the invention resides in a system for providing a street route. The system includes a computer server, a communication link through which a user can communicate with the server, and a database in communication with the server. The database contains a plurality of spherical photographic images, data respecting a plurality of street vectors and coordinates of a plurality of parcels, and computer instructions. Responsive to a request from a user, the instructions cause the server to send start and end addresses designated by the user to a routing engine and to receive from the routing engine parsed start and end addresses and a route between the parsed start and end addresses; to calculate start and end locations corresponding with the parsed start and end addresses; to retrieve spherical photographic images corresponding with the calculated start and end locations; to create rectangular images corresponding with the calculated start and end locations; to generate rectangular images and graphic navigation aids corresponding with maneuver points along the route; and to provide a street route report to the user.

In another embodiment, the invention resides in a method of generating a street route. The method includes receiving in a computer server an electronic request from a user for a street route between user-designated start and end addresses; electronically sending the request to a routing engine; receiving from the routing engine parsed start and end addresses and a route therebetween; calculating start and end locations corresponding with the parsed start and end addresses according to parcel and street vector data; retrieving spherical photographic images corresponding with the calculated start and end locations; creating rectangular images corresponding with the calculated start and end locations; generating rectangular images and graphic navigation aids corresponding with maneuver points along the route; and sending a street route report to the user.

### BRIEF DESCRIPTION OF THE DRAWINGS

FIG. 1 is a block diagram of a system for providing street-level routing according to embodiments of the invention.

FIG. 2 is a flowchart of a method of calculating start and end locations according to embodiments of the invention.

FIG. 3 is a flowchart of a method of generating reports according to embodiments of the invention.

FIG. 4 depicts a portion of a trip route prepared according to an embodiment of the invention.

FIG. 5 depicts a portion of a trip route prepared according to an embodiment of the invention.

FIG. 6 is a flowchart of a method of building an array of start, end, and maneuver points according to embodiments of the invention.

FIG. 7 is a flowchart of a method of adding image paths to an array of points according to embodiments of the invention.

FIG. 8 is a flowchart of a method of creating viewports from spherical photographs according to embodiments of the invention.

### DESCRIPTION OF THE EMBODIMENTS

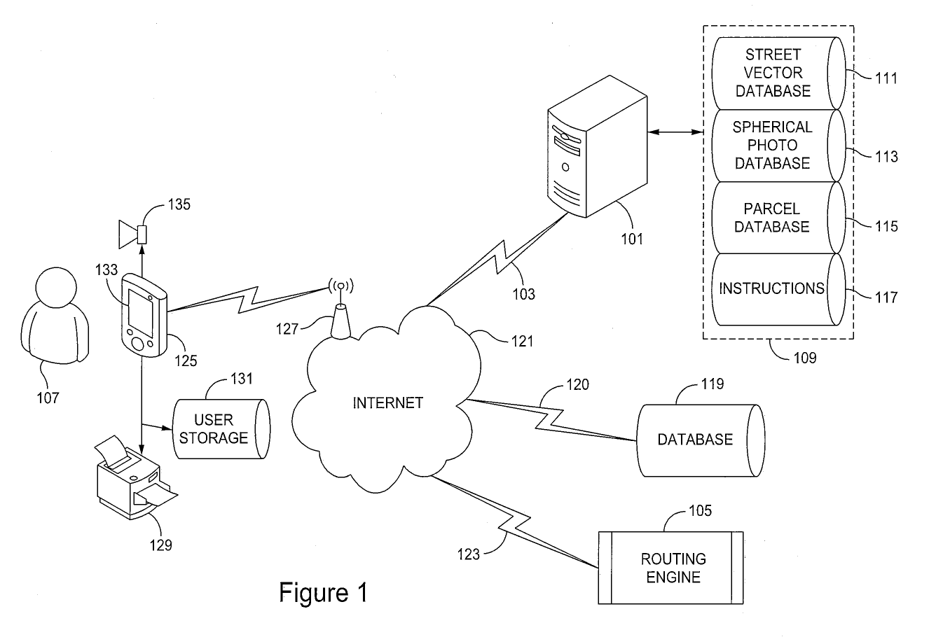

FIG. 1 illustrates a system for providing a street route to a user according to an embodiment of the invention. The system includes a computer server 101. The server communicates through a communication link 103 with a routing engine 105 and with one or more users such as a user 107.

A data storage device 109 is in communication with the server. The data storage device may comprise magnetic media, optical media, computer memory, or any other devices in which electronic data may be stored. The data storage device contains a street vector database 111, a spherical photographic image database 113, a parcel database 115, and computer instructions 117. As illustrated, the data storage device may be physically located adjacent or within the server. Or the data storage device may be remotely located from the server; for example, a data storage device 119 could be remotely located from the server and could communicate with the server through a communication link 120. There may be a plurality of storage devices, some physically adjacent the server and others remotely located, each containing some of the data and instructions, or all the data and instructions may be stored in a single storage device.

The computer instructions 117 cause the server to respond to a request from a user for a street route between user-designated start and end addresses. The server sends these start and end addresses to the routing engine 105. This routing engine may be accessed through the Internet 121 and a communication link 123. The routing engine may be provided by a commercial service such as Google Maps (www.google.com/maps), Yahoo (www.maps.yahoo.com), or Mapquest (www.mapquest.com). In response, the routing engine sends back to the server parsed start and end addresses and a route between the parsed start and end addresses.

As an example of “parsing” an address, an address expressed by the user as “2570 S. Main St.” would be parsed as follows:

| | |
|---|---|
| Number: | 2570 |
| Prefix: | South |
| Street name: | Main |
| Suffix: | Street |

The server calculates start and end locations corresponding with the parsed start and end addresses. For example, to calculate the start location, boundary coordinates are retrieved from the parcel database 115 for that parcel which matches the parsed start address. Coordinates of a centroid of that parcel are computed. From the street vector database 111 a street vector that is adjacent the parcel and that has the same street name as in the parsed address is selected. Coordinates of a location on the selected street vector that is closest to the centroid are calculated.

Spherical photographic images corresponding with the calculated start and end locations are retrieved from the spherical photo database 113 and used to create rectangular images corresponding with the calculated start and end locations. Rectangular images and graphic navigation aids corresponding with maneuver points along the route are generated. Finally, a street route report is provided to the user.

The instructions may cause the server to select an advertisement corresponding with one of the maneuver points and to superimpose the selected advertisement on a rectangular image corresponding with said maneuver point. The advertisement may be selected from a plurality of advertisements according to a characteristic of the user. For example, current or prior interactions with the user may suggest that the user likes Italian restaurants, in which case an advertisement for an Italian restaurant along the route would be selected. Or the user may be queried as to interests the user may have or types of businesses the user may wish to locate along the route, and an appropriate advertisement may be selected based on the user's responses to such queries. Copy for the advertisements may be stored in the data storage device 109 or in a remotely-located database such as the database 119.

The street route report may be transmitted to the user in various ways. For example, if the user communicates by means of a wireless device 125 such as a mobile telephone or wireless PDA, the report may be transmitted to the user through a wireless transmitter 127. The user may communicate by means of a desktop or laptop computer or other device that uses a wireless link, a modem connected to a telephone line or a cable system, or the like.

The report may be provided to the user in a form suitable for printing on a user-designated printer 129 which typically but not necessarily would be remote from the server 101. The report may be stored in a storage device 131 of the user's selection, or the report may be stored remotely from the user, for example in the storage device 109 adjacent the server or in the database 119, and associated with a URL address such that the user can access the report by means of any device that can access a URL over the Internet.

The report may be displayed on a display screen 133 of the user's device 125. This display may be a dynamic display that moves as the user moves. For example, if the user's device has a locating capability such as a Global Positioning Satellite (GPS) receiver, appropriate portions of the report may be displayed as the user travels along the route. Or the display may moved based an estimate of the user's location determined by elapsed time, estimated speed of travel, or some other suitable parameter.

The report may be further transmitted electronically to another user-designated device. Although such a device is not illustrated, it will be apparent that such a device could be located adjacent or remote from the user and might take the form of a mobile phone, GPS receiver, laptop or other computer, or the like. The transmission may be wireless or by any other suitable communication that may go through the Internet, a local or other network, or the like.

The report may be provided audibly to the user, for example through a loudspeaker 135, so that the user need not look at a display while moving along the route.

The spherical photographic images may be displayed directly to the user, or the spherical photographs may be used to create rectangular images oriented in the user's direction of travel. For example, a rectangular image may be calculated by projecting elements of a spherical image onto a virtual rectangular surface.

A precise start location corresponding with the parsed start address may be calculated by retrieving from the parcel database boundary coordinates for that parcel which matches the parsed start address. Coordinates of a centroid of that parcel are calculated, for example by extrapolation. That street vector which is adjacent the parcel and which has the same street name as in the parsed address is selected from the street vector database. A location on the selected street vector that is closest to the centroid is calculated. This calculation may be carried out, for example, by calculating that location on the selected street vector through which passes a line that intersects the centroid and that is perpendicular to the street vector.

A precise end location corresponding with the parsed end address may be calculated in a similar manner.

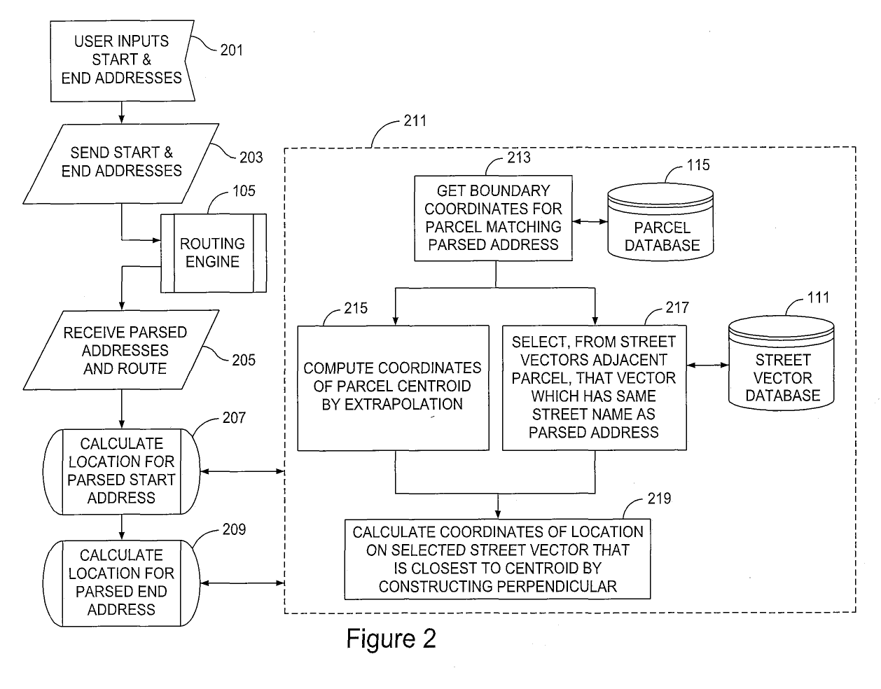

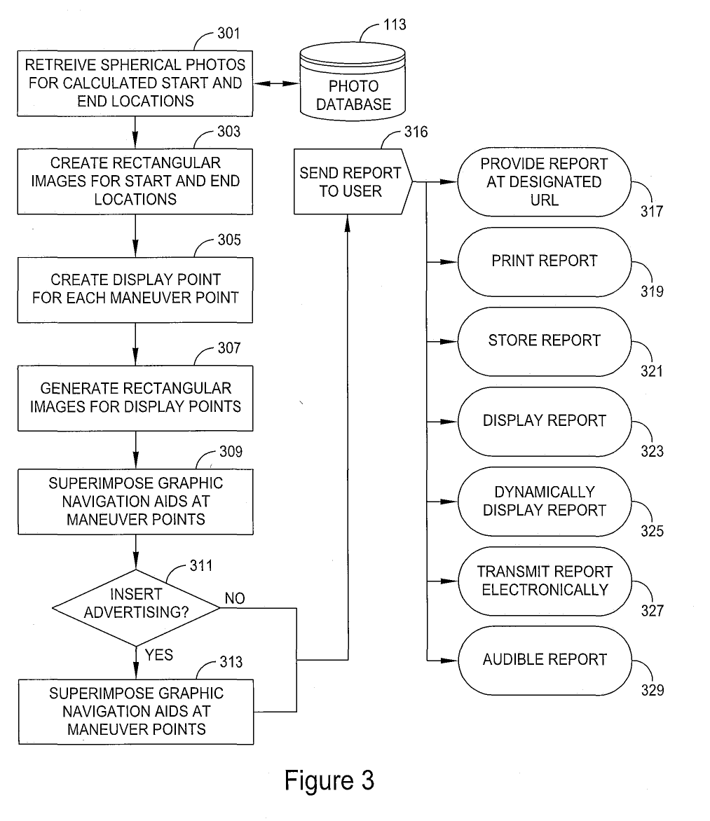

FIGS. 2 and 3 illustrate a method of generating a street route according to the principles of the invention. Calculating start and end locations, as already described above, is shown in FIG. 2. An electronic request from the user, for a street route between start and end addresses designated by the user, is received (201) in a computer server remotely located from the user. The server electronically transmits (203) the user-designated start and end addresses to the routing engine (105), and the server receives (205) from the routing engine parsed start and end addresses and a route between the parsed start and end addresses. A start location corresponding with the parsed start address is calculated (207) according to parcel and street vector data. Similarly, an end location corresponding with the parsed end address is calculated (209).

In the embodiment shown, the start location is calculated and then the end location is calculated, but inasmuch as both calculations are performed very rapidly, the end location could be calculated first or both could be calculated in parallel. A procedure (211) for performing these calculations, as already described above, includes retrieving from the parcel database (115) parcel information including boundary coordinates (213) for that parcel which matches the parsed address, computing (215) coordinates of a centroid of that parcel, selecting (217) from street vector data in the street vector database (111) that street vector which is adjacent the parcel and which has the same street name as in the parsed address, and calculating coordinates (219) of a location on the selected street vector that is closest to the centroid.

Computing (215) coordinates of the centroid of the parcel may be accomplished by extrapolating between boundaries of the parcel.

Calculating coordinates (219) of the closest location on the selected street vector to the centroid may be done by calculating that location on the selected street vector through which passes a line that intersects the centroid and that is perpendicular to the street vector.

Generating reports for the user is shown in FIG. 3. Spherical photographic images corresponding with the calculated start and end location are retrieved (301) from the photo database (113). A spherical photograph gives a full circle view of what a viewer would see at the location of the photograph if the viewer while standing at that point turned his head and eyes through a full 360°. The spherical photograph may be displayed to the user or included in the report, but typically a rectangular image is created to show what the user would see when facing in the desired direction of travel. Such images are created for the start and end locations (303) which have been calculated as described above, and for display points corresponding with maneuver points along the route.

The maneuver points will have been provided by the routing engine in the route provided by it. For each such maneuver point, coordinates of a desired display point are calculated (305) and a rectangular image is generated (307) for each display point. The display point may be located about forty feet prior to the maneuver point such that the actual maneuver point is in front of the direction of travel. A rectangular photograph projected from the desired display point will show the user what he would see when he is forty feet from the maneuver point and facing in the direction of travel.

Graphic navigation aids, for example arrows indicating directions of turns, are generated and superimposed on the rectangular images (309). Examples of such aids include directional arrows indicating that the user is to proceed straight ahead (forward), turn right, bend-right, turn left, bend-left, or make a U-turn. The arrow may indicate some combination of turns as appropriate. A special graphic navigation aid, for example a representation of a brightly colored flag, may be generated and superimposed to designate the destination.

As described above, an advertisement corresponding with one of the maneuver points may be selected (311) and superimposed on a rectangular image corresponding with said maneuver point (313). Any of a plurality of advertisements may be selected according to a characteristic of the user.

A street route report is sent (315) to the user. This report includes the calculated start and end locations, the route as provided by the route engine, rectangular images of the start and end locations and of maneuver points, and graphical navigation aids for the maneuver points. Optionally, one or more spherical photographic images may be included. The report may include an overall route map; textual directions with maneuver points described textually; and detail maps depicting any portion of the route including maneuver points with graphic navigation aids. If an exact match for a starting or destination address was not found during the calculation of coordinates of the starting and destination addresses, the user is so informed.

At the user's option, the report may be made accessible (317) at a URL designated by the server, printed (319) on a printer selected by the user, stored (321) in a user storage device, displayed (323) or dynamically displayed (325) on a user device, transmitted (327) to a location selected by the user, or presented audibly (329) through a user-designated device.

If the user elects to store the report, the report may be stored on a storage medium such as a CD, a portable hard disk, or a USB storage device. Or it may be downloaded into an appliance such as a laptop computer, a GPS receiver, or a mobile phone.

If the report is presented audibly, the textual directions may be reproduced by a spoken voice in sync with the display of graphical navigation aids, so the user can receive the directions while driving without having to look at the textual reproduction, map or rectangular image then being displayed.

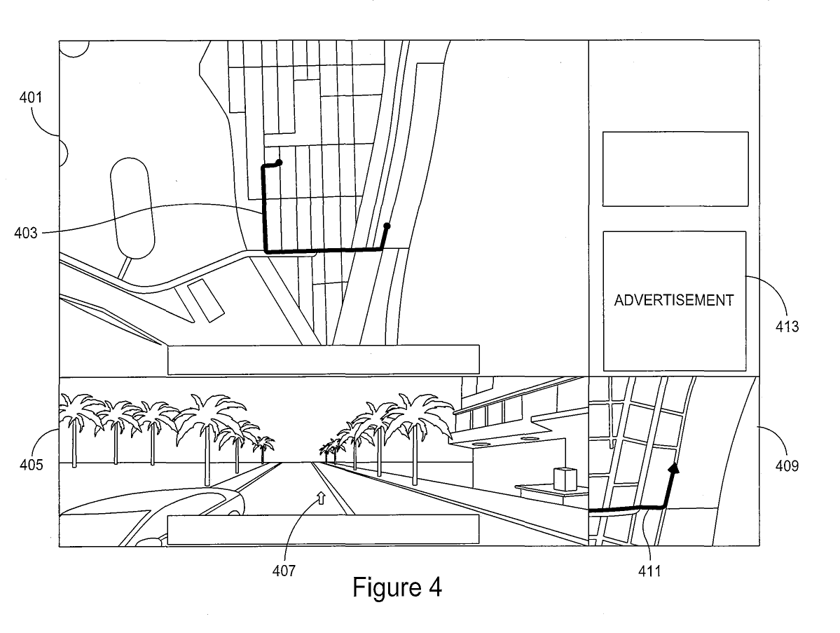

FIG. 4 shows a portion of a route report prepared according to an embodiment of the invention. An overall map 401 is presented in one portion of the report, with the actual route 403 highlighted, for example with shading or by being traced in a contrasting color. Adjacent the map is a rectangular image 405, being a photograph showing the street and adjacent buildings and other landmarks as the user would see them at this point on the trip. A graphical navigation aid 407, in this case a straight-ahead arrow, is superimposed on the image to show which direction the user should follow. Adjacent the image is a close-up map 409 of one portion 411 of the route, highlighted and with a directional arrow to show the direction of travel. An optional advertisement 413 is displayed adjacent the map 401. As displayed, the map 401 is in an upper left quadrant of the page, the image 405 is in a lower left quadrant, the close-up map 409 is in a lower right quadrant, and the advertisement 413 is in an upper right quadrant, but these elements may be arranged differently as desired. A textual description of some or all of the route may also be included.

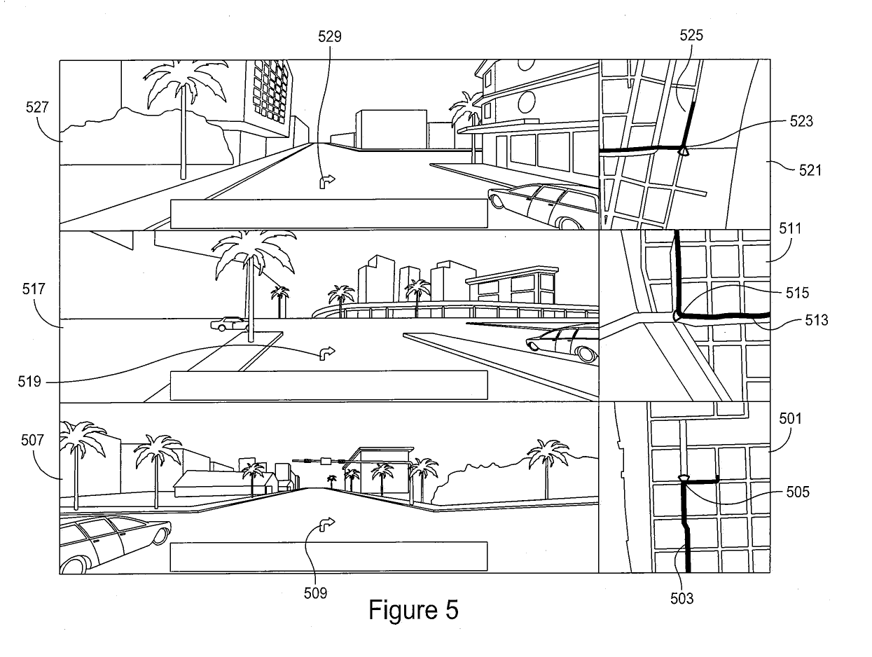

FIG. 5 shows a portion of a route report prepared according to an embodiment of the invention. A first detail map 501 shows a portion of the route 503 highlighted and a first maneuver point 505. A first rectangular image 507 adjacent this map shows the route about 40 feet in advance of the maneuver point 505 with a superimposed graphical navigation aid 509 in the shape of a right-turn arrow, indicating the maneuver point at which a right turn is to be made. Similarly, a second detail map 511 shows a portion of the route 513 highlighted and a second maneuver point 515. A second rectangular image 517 adjacent this map shows the route about 40 feet in advance of the maneuver point 515 with a superimposed graphical navigation aid 519, again in the shape of a right-turn arrow, indicating the maneuver point at which a right turn is to be made. A third detail map 521 shows a portion of the route 523 highlighted and a third maneuver point 525. A third rectangular image 527 adjacent this map shows the route about 40 feet in advance of the maneuver point 525 with a superimposed graphical navigation aid 529, once again in the shape of a right-turn arrow, indicating the maneuver point at which a right turn is to be made.

Various embodiments and aspects of the invention will now be described in more detail.

The street vector database 109 may be obtained from commercial vendors. One such database is available from Navteq Corporation of Chicago, Ill. When accessing street vectors, variations in prefixes and suffixes are compensated for. As an example, the prefix “South”, the prefix “So” and the prefix “S.” would all he considered as equivalent in locating the street vector that corresponds with the address provided by the user in the example above.

The parcel database 115 may also be obtained from commercial vendors. It may be included in the same product as the street vector database or it may be obtained separately. If not available from the database, the boundaries of that parcel which corresponds with an address designated by the user may be determined by: identifying a block range that includes the address number; determining (typically by whether the address number is even or odd) which side of the street the address is on; extrapolating along the street vector to obtain approximate coordinates of the address number; identifying any parcels close to these coordinates; and determining which parcel matches the parsed address.

It may happen that no parcel can be identified with the address provided by the user. In this situation, an internal flag is set so that when processing the route report the user is informed that an exact match was not found.

Embodiments of the invention provide a comprehensive and detailed step-by-step precision street-level routing report that can be displayed on any device that can utilize a simple html format report. Such devices include cell phones and other mobile devices with limited html implementation capabilities and restricted, limited or unavailable Web application plug-ins. The user device needs only to be able to communicate with the server by means of, for example, a single JavaScript/Ajax method that passes the start and end address. Such a light client-side JavaScript application requires less than 100 lines of code to implement and will run on most browser-enabled cell phones and other mobile devices.

When a report has been prepared according to the principles of the invention, the report may be stored by the server in one of its own databases. A URL link is returned to the user such that the user can retrieve the report at any time by means of the link.

The report may be prepared in as much or as little detail as the user may request. For example, a report including up to about eleven maneuver points, sufficient for many trips, may fit on a single letter-size sheet of paper. A more detailed report may include, on a first page, a map of the entire route and optionally a location-sensitive advertisement near the end location. Following the first page are step-by-step routing directions along with rectangular images for each display point and a street map. The map may include a graphical indication, for example a pie-shaped shading, showing the orientation of each rectangular image.

Industry-standard geocoding algorithms, such as those used by most Internet mapping applications, do not provide accurate start and end locations. Embodiments of the invention, as previously described, overcome this shortcoming to provide a user with a trip route, map, and images that accurately portray the start and end locations.

In some embodiments of the invention, approximate coordinates for the start address provided by the user are obtained from a standard geocoding service. Then each parcel within a short distance of these coordinates, such as one-quarter mile, is identified and checked to see which one matches the address. When a matching parcel has been found, its coordinates are used to determine the exact start location as described previously. In a similar manner, the exact end location is determined.

Providing a trip route with exact start and end locations can be critical in such applications as emergency responses by police or fire services, or for real estate agents.

In some embodiments, the exact coordinates of the start and end locations are determined and then fed back to the routing engine to obtain an exact route. This exact route is then used to generate the user report as described above. In other embodiments, these exact coordinates are used along with the route already provided by the routing engine to generate the user report.

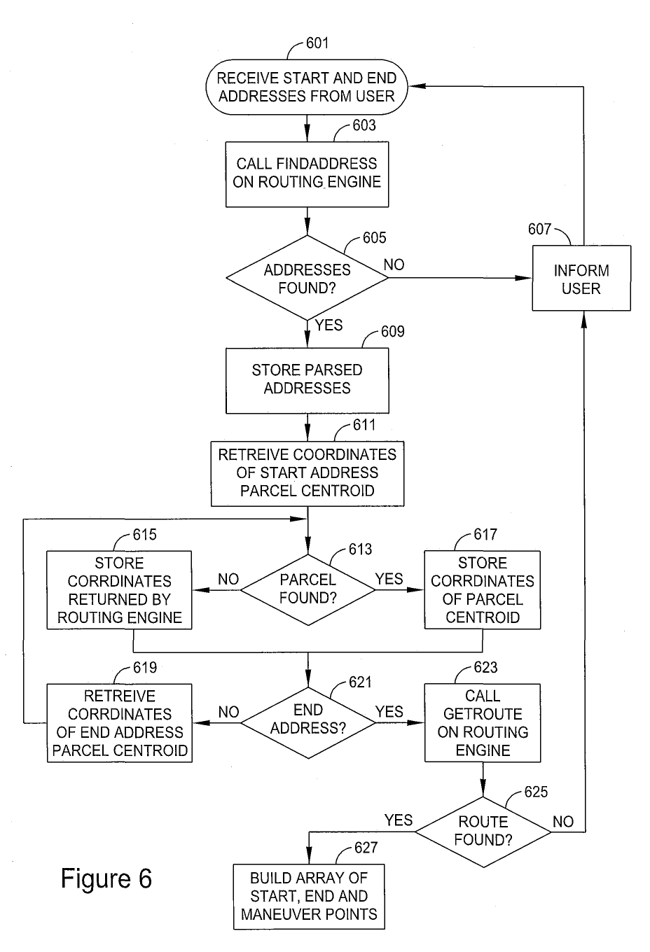

As shown in FIG. 6, in some embodiments start and end addresses are received (601) from the user and provided in a function call (603) to a FindAddress routine in the routing engine. If either address is not found (605), the user is so informed (607). Each address is parsed and stored (609).

Coordinates—latitude and longitude—of a centroid of a parcel corresponding with the start address are retrieved (611) from a parcel database. If a parcel corresponding with the address is not found (613), coordinates for that address as provided by the routing engine are stored (615). If a parcel is found, coordinates for a centroid of that parcel are stored (617). The process is repeated (619) for the end address (621).

A function call (623) is made to a GetRoute routine in the routing engine. If no route is returned (625), the user is informed (607). Otherwise, an array is assembled (627) comprising the stored start and end coordinates and maneuver points in the route returned by the routing engine.

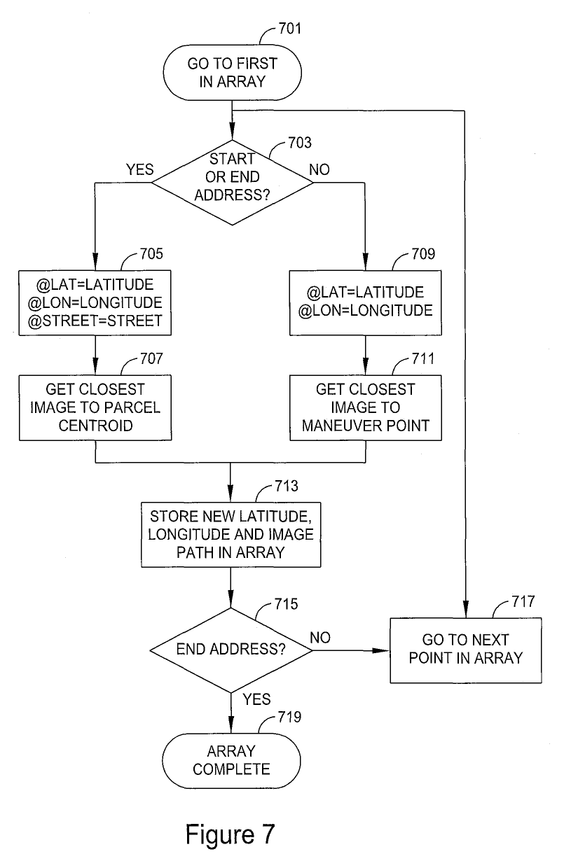

As shown in FIG. 7, a photographic image is obtained for each point in the array. Beginning with the first point in the array (701), if the point is a start or end address (703), variables including @lat, @lon, and @street are set (705) with values corresponding with that point in the array, and a routine Get closest image to parcel centroid is invoked (707). If the point is a maneuver point, variables including @lat and @lon are set (709) with values corresponding with that point in the array, and a routine Get closest image to maneuver point is invoked (711). After each invocation of either routine, the new latitude, longitude and image path are stored in the array (713). If the end address was not processed (715) the next point in the array is selected (717) and the process repeats. When the end address has been processed, the array is complete (719).

The routine Get closest image to maneuver point may be implemented as follows:

```
PK HANDLE
        LAT
        LON
        MERCATORX
        MERCATORY
        IMAGEPATH
        STREET
GET CLOSEST IMAGE TO MANEUVER POINT
select top 1 HANDLE
        , LAT
        , LON
        , IMAGEPATH
from IMAGES
where LAT between @lat−0.0001 and @lat+0.0001
        and LON between @lon−0.0001 and @lon+0.0001
order by dbo.fnRelativeDistance(LAT, LON,@lat,@lon)
```

The routine Get closest image to parcel centroid may be implemented as follows:

GET CLOSEST IMAGE TO PARCEL CENTROID

```
select top 1 HANDLE
    , LAT
    , LON
    , IMAGEPATH
from IMAGES
where LAT between @lat−0.0001 and @lat+0.0001
    and LON between @lon−0.0001 and @lon+0.0001
    and STREET = @street
order by dbo.fnRelativeDistance(LAT,LON,@lat,@lon)
```

The subroutine fnRelativeDistance may be implemented as follows:

fnRelativeDistance

```
[Microsoft. SqlServer.Server.SqlFunction]
public static SqlDouble fnRelativeDistance(double lat1,
double lon1, double lat2, double lon2)
{
  double x1,y1;
  double x2,y2;
  LLtoXY(lat1, lon1, out x1, out y1);
  LLtoXY(lat2, lon2, out x2, out y2);
  double dx = x2 − x1;
  double dy = y2 − y1;
  return dx * dx + dy * dy;
}
public static void LLtoXY(double lat, double lon, out double x,
out double y)
{
  try
  {
    double a = 6378137;  //Earth radius
    double radLat = (Math.PI / 180.0) * lat;
    double radLon = (Math.PI / 180.0) * lon;
    double FE = 20000000; //False East
    double FN = 0;  //False North
    x = FE + (a * radLon);
    y = FN + (a * Math.Log((Math.Tan(Math.PI / 4 + radLat / 2))));
  }
  catch (Exception ex)
  {
    throw ex;
  }
}
```

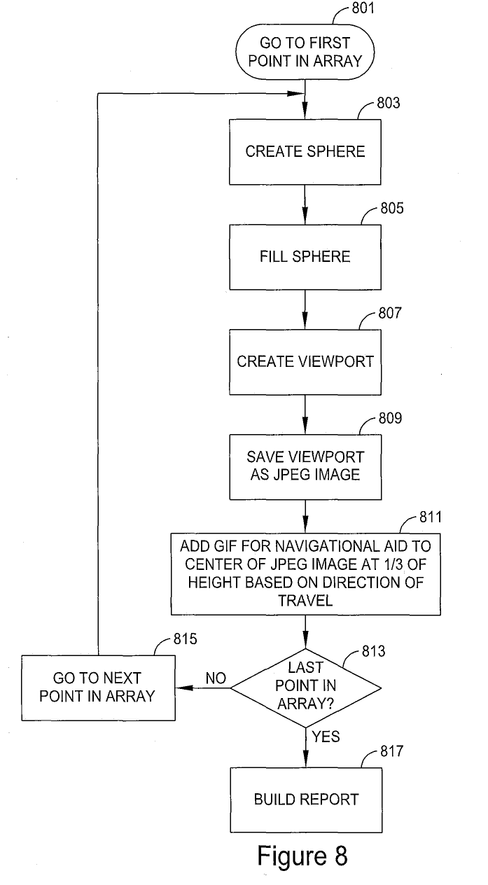

As shown in FIG. 8, images are constructed for each point in the array (801). A sphere is created (803), for example by OpenGL, a three dimensional library available in most versions of the Microsoft Windows operating system. The sphere may be twenty meters in diameter. The sphere is filled (805), for example by using OpenGL to create a texture filling the inside of the sphere with an image for the point. A viewport is created (807), for example three meters high by four meters wide. The content of the viewport is saved (809), for example as a JPEG compressed file. A navigational aid, for example in the GIF format, is added to the saved viewport image (811). The navigational aid may take the form of an arrow centered in the image and about one-third height from the bottom of the image and oriented according to direction of travel. The navigation aid may be an arrow indicating, for example, turn left or right, bear left or right, U-turn, or straight ahead.

If the last point in the array has not been reached (813) the next point is selected (815) and the process repeated. When images have been constructed for all the points, the report may be built (817). As the report is being built, or just before, advertising images may be inserted as desired.

While certain embodiments have been described and illustrated, the invention is not to be limited to these descriptions and illustrations. The invention is limited only by the claims.

We claim:

1. A system for providing a street route to a user comprising:
a computer server;
a communication link through which the server communicates with a routing engine and with one or more users;
a database in communication with the server;
a plurality of spherical photographic images stored in the database;
data respecting a plurality of street vectors stored in the database;
coordinates of a plurality of parcels stored in the database; and
computer instructions stored in the database that cause the computer server, responsive to a request from a user for a street route between user-designated start and end addresses, to:
(a) send the start and end addresses to the routing engine and to receive from the routing engine parsed start and end addresses and a route between the parsed start and end addresses;
(b) calculate start and end locations corresponding with the parsed start and end addresses;
(c) retrieve spherical photographic images corresponding with the calculated start and end locations;
(d) create rectangular images corresponding with the calculated start and end locations;
(e) generate rectangular images and graphic navigation aids corresponding with maneuver points along the route; and
(f) provide a street route report to the user.

2. A system as in claim 1 wherein the computer instructions cause the server to select an advertisement corresponding with one of the maneuver points and to superimpose the selected advertisement on a rectangular image corresponding with said maneuver point.

3. A system as in claim 2 wherein the advertisement is selected from a plurality of advertisements according to a characteristic of the user.

4. A system as in claim 1 wherein step (f) comprises at least one of:
making the report accessible through a pre-specified Internet address;
printing the report on a user-designated printer remote from the server;
storing the report in a user storage device;
displaying the report on a user device remote from the server;
dynamically displaying the report on a user device;
transmitting the report electronically to a user-designated device; and
providing the report audibly to the user through a user-designated device.

5. A system as in claim 1 wherein step (d) comprises calculating a projection of a spherical image upon a rectangular surface.

6. A system as in claim 1 wherein step (b) comprises:
(g) retrieving from the database boundary coordinates for that parcel which matches the parsed start address;
(h) computing coordinates of a centroid of that parcel;
(i) selecting from the data respecting street vectors that street vector which is adjacent the parcel and which has the same street name as in the parsed address;
(j) calculating coordinates of a location on the selected street vector that is closest to the centroid; and
(k) repeating steps (g) through (j) for the parsed end address.

7. A system as in claim 6 wherein step (h) comprises extrapolating between boundaries of the parcel.

8. A system as in claim 6 wherein step (0) comprises calculating that location on the selected street vector through which passes a line that intersects the centroid and that is perpendicular to the street vector.

9. A method of generating a street route comprising:
(a) receiving in a computer server remotely located from a user an electronic request from the user for a street route between start and end addresses designated by the user;
(b) electronically transmitting the user-designated start and end addresses to a routing engine;
(c) electronically receiving from the routing engine parsed start and end addresses and a route between the parsed start and end addresses;
(d) calculating start and end locations corresponding with the parsed start and end addresses according to parcel and street vector data in a database;
(e) retrieving from a database spherical photographic images corresponding with the calculated start and end locations;
(f) creating rectangular images corresponding with the calculated start and end locations;
(g) generating rectangular images and graphic navigation aids corresponding with maneuver points along the route; and
(h) sending a street route report to the user.

10. A method as in claim 9 and further comprising:
selecting an advertisement corresponding with one of the maneuver points; and
superimposing the selected advertisement on a rectangular image corresponding with said maneuver point.

11. A method as in claim 10 wherein selecting an advertisement comprises selecting one of a plurality of advertisements according to a characteristic of the user.

12. A method as in claim 9 wherein step (h) comprises, responsive to a user command, at least one of:
making the report accessible through a pre-specified Internet address;
printing the report on a user-designated printer remote from the computer server;
storing the report in a user storage device;
displaying the report on a user device remote from the server;
dynamically displaying the report on a user device;
transmitting the report electronically to a user-designated device; and
providing the report audibly to the user through a user-designated device.

13. A method as in claim 9 wherein step (f) comprises calculating a projection of a spherical image upon a rectangular surface.

14. A method as in claim 1 wherein step (d) comprises:
(i) retrieving from the database boundary coordinates for that parcel which matches the parsed start address;
(j) computing coordinates of a centroid of that parcel;
(k) selecting from the data respecting street vectors that street vector which is adjacent the parcel and which has the same street name as in the parsed address;
(l) calculating coordinates of a location on the selected street vector that is closest to the centroid; and
(m) repeating steps (i) through (l) for the parsed end address.

15. A method as in claim 14 wherein step (j) comprises extrapolating between boundaries of the parcel.

16. A method as in claim 14 wherein step (l) comprises calculating that location on the selected street vector through which passes a line that intersects the centroid and that is perpendicular to the street vector.

17. A method of generating a street route comprising:
(a) receiving in a computer server a request transmitted through a remotely-located electronic device from a user for a street route between start and end addresses designated by the user;
(b) electronically transmitting the user-designated start and end addresses to a routing engine;
(c) electronically requesting from the routing engine parsed start and end addresses and start and end coordinates;
(d) if the routing engine fails to locate one of the addresses, informing the user;
(e) retrieving from a parcel database coordinates of a parcel matching the parsed start address;
(f) if no parcel was retrieved in step (e), storing the start coordinates received from the routing engine, and if a parcel was retrieved, storing coordinates of that parcel;
(g) retrieving from the parcel database coordinates of a parcel matching the parsed end address;
(h) if no parcel was retrieved in step (g), storing the end coordinates received from the routing engine, and if a parcel was retrieved, storing coordinates of that parcel;
(i) providing both stored coordinates to the routing engine and requesting a route from the routing engine;
(j) if no route is received, informing the user;
(k) if a route is received, building an array of start, end and maneuver points;
(l) locating in a photo database a closest image for each point in the array; and
(m) assembling a report that includes each point in the array and the images located in step (l).

18. A method as in claim 17 wherein step (l) comprises:
(n) for each point in the array, creating and filling a sphere;
(o) for each sphere, creating a viewport;
(p) saving each viewport in the array.

19. A method as in claim 17 wherein step (m) comprises superimposing graphic navigation aids on the images corresponding with maneuver points.

20. A method as in claim 17 wherein step (m) comprises, responsive to a user command, at least one of:
making the report accessible through a pre-specified Internet address;
printing the report on a user-designated printer remote from the computer server;
storing the report in a user storage device;
displaying the report on a user device remote from the server;
dynamically displaying the report on a user device;
transmitting the report electronically to a user-designated device; and
providing the report audibly to the user through a user-designated device.
